(19) United States
(12) Patent Application Publication
(10) Pub. No.: US 2023/0230737 A1
(43) Pub. Date: Jul. 20, 2023

(54) MULTILAYER COIL COMPONENT

(71) Applicant: TDK CORPORATION, Tokyo (JP)

(72) Inventors: Yusuke NAGAI, Tokyo (JP); Kazuhiro EBINA, Tokyo (JP); Kunihiko KAWASAKI, Tokyo (JP); Shinichi KONDO, Tokyo (JP); Kouichi KAKUDA, Tokyo (JP); Shinichi SATO, Tokyo (JP); Keito YASUDA, Tokyo (JP)

(73) Assignee: TDK CORPORATION, Tokyo (JP)

(21) Appl. No.: 18/151,070

(22) Filed: Jan. 6, 2023

(30) Foreign Application Priority Data
Jan. 20, 2022 (JP) 2022-007263

(51) Int. Cl. H01F 5/00; H01F 1/20

(52) U.S. Cl. CPC H01F 5/003; H01F 1/20

(57) ABSTRACT

A multilayer coil component includes: an element body including a plurality of magnetic layers that includes soft magnetic metal particles and is laminated in a first direction; and a coil disposed in the element body. The coil includes a plurality of coil conductors electrically connected to each other. The plurality of magnetic layers includes a first magnetic layer and a second magnetic layer laminated between two coil conductors adjacent to each other in the first direction. An average particle diameter of soft magnetic metal particles included in the second magnetic layer is larger than an average particle diameter of soft magnetic metal particles included in the first magnetic layer.

### TECHNICAL FIELD

The present disclosure relates to a multilayer a coil component. This application is based upon and claims the benefit of priority from Japanese Patent Application No. 2022-007263, filed on Jan. 20, 2022, the entire contents of which are incorporated herein by reference.

### BACKGROUND

Japanese Patent Application Laid-Open No. 2013-38263 discloses a multilayer inductor including a magnetic portion formed by laminating layers containing soft magnetic alloy particles, a coil disposed in the magnetic portion, and external terminals provided at both end portions of the magnetic portion and connected to the coil.

### SUMMARY

When the particle diameter of the soft magnetic alloy particles is increased, the L value of the coil can be increased, but it is difficult to secure the withstand voltage between the coil conductors. On the other hand, when the particle diameter of the soft magnetic alloy particles is reduced, it is possible to secure the withstand voltage between the coil conductors, but it is difficult to increase the L value of the coil.

A purpose of the present disclosure is to provide a multilayer coil component capable of increasing an L value of a coil while securing a withstand voltage between coil conductors.

A multilayer coil component according to an aspect of the present disclosure includes: an element body including a plurality of magnetic layers that includes soft magnetic metal particles and is laminated in a first direction; and a coil disposed in the element body. The coil includes a plurality of coil conductors electrically connected to each other. The plurality of magnetic layers includes a first magnetic layer and a second magnetic layer laminated between two coil conductors adjacent to each other in the first direction. An average particle diameter of soft magnetic metal particles included in the second magnetic layer is larger than an average particle diameter of soft magnetic metal particles included in the first magnetic layer.

In the multilayer coil component according to the aspect of the present disclosure, the first magnetic layer and the second magnetic layer are disposed between adjacent coil conductors. The average particle diameter of the soft magnetic metal particles included in the first magnetic layer is different from the average particle diameter of the soft magnetic metal particles included in the second magnetic layer. Therefore, at least two soft magnetic metal particles are likely to be disposed between adjacent coil conductors along the first direction. Accordingly, it is possible to secure the withstand voltage between adjacent coil conductors compared to a case in which the magnetic layer is disposed as a single layer. In addition, compared to a case in which two magnetic layers having a small average particle diameter are disposed, the magnetic permeability is improved. As a result, the L value of the coil can be increased.

The first magnetic layer may be thinner than the second magnetic layer. In this case, the L value of coil can be reliably increased.

The first magnetic layer may be thicker than the second magnetic layer. In this case, it is possible to reliably secure the withstand voltage between the coil conductors.

The plurality of magnetic layers may further include a plurality of third magnetic layers that is disposed around a corresponding coil conductor when viewed from the first direction and constitutes the same layer as the corresponding coil conductor. An average particle diameter of soft magnetic metal particles included in the plurality of third magnetic layers may be larger than the average particle diameter of soft magnetic metal particles included in the first magnetic layer. In this case, the L value of coil can be further increased.

Each of the first magnetic layer and the second magnetic layer may overlap with the plurality of coil conductors when viewed from the first direction and has a line width wider than a line width of the plurality of coil conductors. The plurality of magnetic layers may further include a third magnetic layer that is disposed around the first magnetic layer and the second magnetic layer when viewed from the first direction and constitutes the same layer as the first magnetic layer and the second magnetic layer. An average particle diameter of soft magnetic metal particles included in the third magnetic layer may be larger than the average particle diameter of soft magnetic metal particles included in the first magnetic layer. In this case, the L value of the coil can be further increased compared to a configuration in which the average particle diameter of the soft magnetic metal particles included in the third magnetic layer is equal to or less than the average particle diameter of the soft magnetic metal particles included in the first magnetic layer.

The average particle diameter of soft magnetic metal particles included in the third magnetic layer may be larger than the average particle diameter of soft magnetic metal particles included in the second magnetic layer. In this case, the L value of coil can be further increased.

The multilayer coil component may further include a high resistance portion disposed between the two coil conductors and having an electrical resistivity higher than an electrical resistivity of each of the first magnetic layer and the second magnetic layer. The high resistance portion may overlap the plurality of coil conductors when viewed from the first direction and have a line width wider than a line width of the plurality of coil conductors. In this case, it is possible to reliably secure the withstand voltage between the coil conductors.

The high resistance portion may be disposed so as to be in contact with one of the two coil conductors. In this case, the magnetic flux generated in the element body when the alternating current flows through the coil conductor becomes larger as the magnetic flux is closer to the coil conductor. Therefore, the alternating current loss can be further suppressed.

A mixed region in which soft magnetic metal particles having small particle diameters and soft magnetic metal particles having large particle diameters are mixed may be present between the first magnetic layer and the second magnetic layer. In this case, it is possible to more reliably secure the withstand voltage between the coil conductors.

### BRIEF DESCRIPTION OF THE DRAWINGS

FIG. 1 is a perspective view illustrating a multilayer coil component according to a first embodiment.

FIG. 2 is an exploded perspective view of the multilayer coil component shown in FIG. 1.

FIG. 3 is a cross-sectional view of the multilayer coil component shown in FIG. 1.

FIG. 4 is a perspective view showing a first end portion of a first connection conductor.

FIG. 5 is a partially enlarged view of FIG. 3.

FIG. 6 is a partially enlarged cross-sectional view of a multilayer coil component according to a second embodiment.

FIG. 7 is a plan view of the multilayer coil component shown in FIG. 6.

FIG. 8 is a partially enlarged cross-sectional view of a multilayer coil component according to a third embodiment.

FIG. 9 is a partially enlarged cross-sectional view of a multilayer coil component according to a fourth embodiment.

### DETAILED DESCRIPTION

Hereinafter, embodiments will be described in detail with reference to the accompanying drawings. In the description of the drawings, the same or corresponding elements are denoted by the same reference numerals, and redundant description is omitted.

### First Embodiment

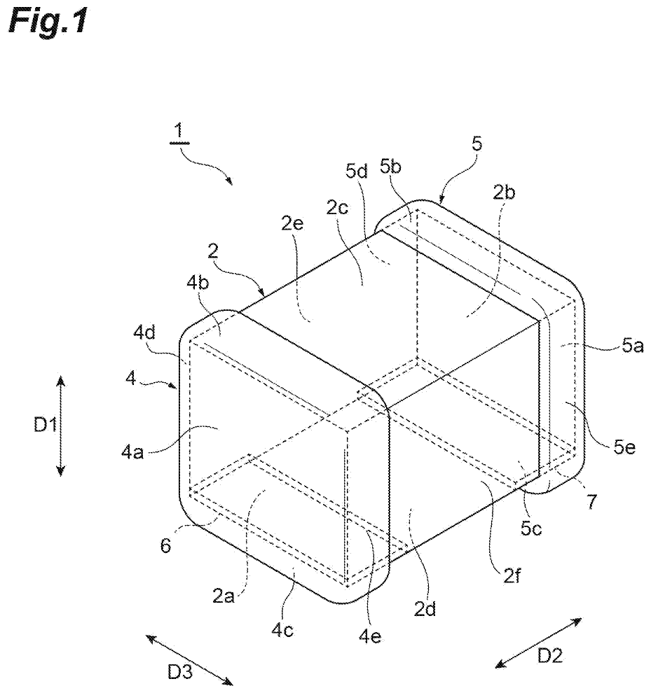

As shown in FIG. 1, a multilayer coil component 1 according to a first embodiment includes an element body 2, a first external electrode 4, a second external electrode 5, a first electrode part 6, and a second electrode part 7.

The element body 2 has a substantially rectangular parallelepiped shape. The rectangular parallelepiped shape includes a rectangular parallelepiped shape in which corner portions and ridge portions are chamfered and a rectangular parallelepiped shape in which corner portions and ridge portions are rounded. The element body 2 has, as its outer surface, a pair of end surfaces 2a and 2b opposing each other, a pair of main surfaces 2c and 2d opposing each other, and a pair of side surfaces 2e and 2f opposing each other. An opposing direction in which the pair of main surfaces 2c and 2d are opposed to each other is a first direction D1. An opposing direction in which the pair of end surfaces 2a and 2b are opposed to each other is a second direction D2. An opposing direction in which the pair of side surfaces 2e and 2f are opposed to each other is a third direction D3. In the present embodiment, the first direction D1 is a height direction of the element body 2. The second direction D2 is a longitudinal direction of the element body 2 and is orthogonal to the first direction D1. The third direction D3 is a width direction of the element body 2 and is orthogonal to the first direction D1 and the second direction D2.

The pair of end surfaces 2a and 2b extends in the first direction D1 so as to connect between the pair of main surfaces 2c and 2d. The pair of end surfaces 2a and 2b also extends in the third direction D3 (short side direction of the pair of main surfaces 2c and 2d). The pair of side surfaces 2e and 2f extends in the first direction D1 so as to connect between the pair of main surfaces 2c and 2d. The pair of side surfaces 2e and 2f also extends in the second direction D2 (long side direction of the pair of end surfaces 2a and 2b). The main surface 2d may be defined as a mounting surface that faces another electronic device (for example, a circuit board or an electronic component) when the multilayer coil component 1 is mounted on the other electronic device.

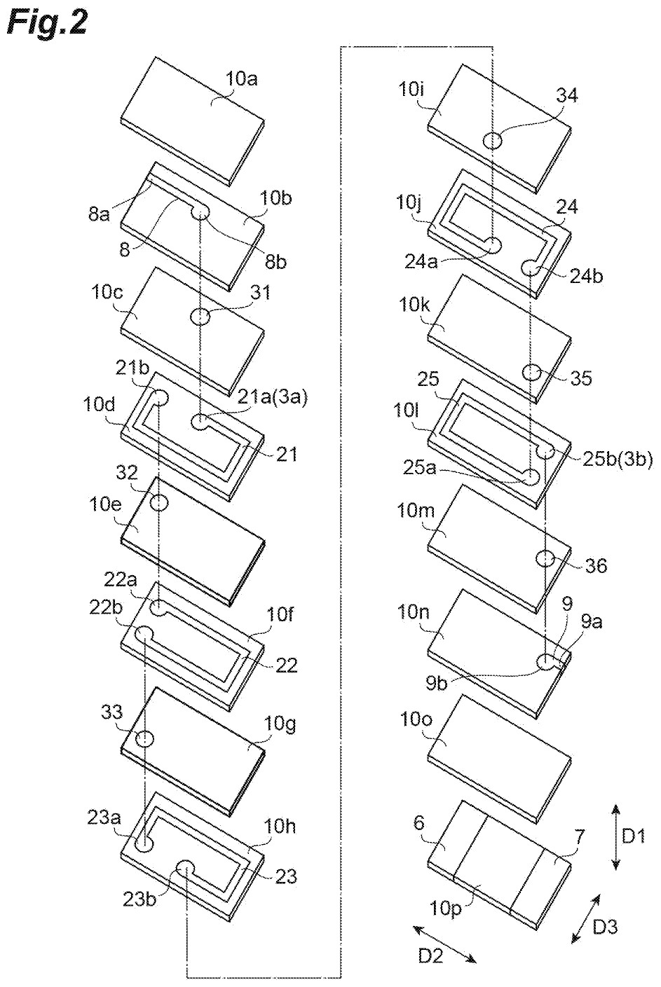

As shown in FIG. 2, the element body 2 includes a plurality of magnetic layers 10a to 10p that are laminated in the first direction D1. The element body 2 is formed by laminating a plurality of magnetic layers 10a to 10p in the first direction D1. Each of the magnetic layers 10a to 10p is laminated in this order in the first direction D1. That is, the first direction D1 is the laminating direction. In the actual element body 2, the magnetic layers 10a to 10p are integrated to such an extent that the boundary between the layers cannot be visually recognized. In FIG. 2, each of the magnetic layer 10a to 10p is illustrated one by one, but a plurality of magnetic layers 10a and a plurality of magnetic layers 10o are laminated. The main surface 2c is constituted by the main surface of the magnetic layer 10a located at the laminated end. The main surface 2d is constituted by the main surface of the magnetic layer 10p.

The thicknesses of each magnetic layer 10a to 10p (lengths of the first direction D1) are, for example, 1 μm or more 100 μm or less. In FIG. 2, the thicknesses of the magnetic layers 10a to 10p are shown to be equal, but the magnetic layers 10b, 10d, 10f, 10h, 10j, 10l, and 10n are thicker than the magnetic layers 10c, 10e, 10g, 10i, 10k, 10m, and 10o. The coil conductors 21 to 25, a first connection conductor 8, and a second connection conductor 9 described later are provided in the magnetic layers 10b, 10d, 10f, 10h, 10j, 10l, and 10n. The through-hole conductors 31 to 36 described later are provided in the magnetic layers 10c, 10e, 10g, 10i, 10k, 10m, and 10o. The thicknesses of the magnetic layers 10b, 10d, 10f, 10h, 10j, 10l, and 10n are equal to each other in the present embodiment and are, for example, 15 μm or more 100 μm or less. The thicknesses of the magnetic layers 10c, 10e, 10g, 10i, 10k, 10m, and 10o are equal to each other in the present embodiment and are, for example, 1 μm or more 15 μm or less.

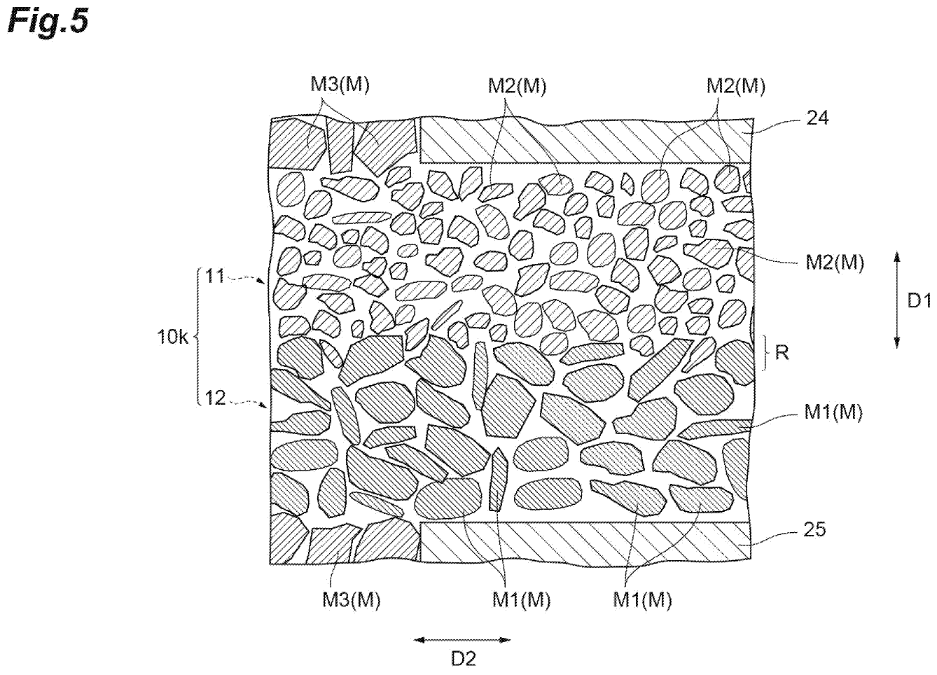

Each of the magnetic layers 10a to 10p includes a plurality of soft magnetic metal particles M (see FIG. 5). The soft magnetic metal particles M is made of a soft magnetic alloy (soft magnetic material). The soft magnetic alloy is, for example, an Fe—Si-based alloy. When the soft magnetic alloy is the Fe—Si-based alloy, the soft magnetic alloy may contain P. The soft magnetic alloy may be, for example, an Fe—Ni—Si-M-based alloy. “M” includes one or more elements selected from Co, Cr, Mn, P, Ti, Zr, Hf, Nb, Ta, Mo, Mg, Ca, Sr, Ba, Zn, B, Al, and rare earth elements.

The soft magnetic metal particles M are coupled to each other in each of the magnetic layers 10a to 10p. The coupling between the soft magnetic metal particles M is realized by coupling between oxide films formed on surfaces of the soft magnetic metal particles M, for example. The soft magnetic metal particles M are electrically insulated from each other by coupling of oxide films in each of the magnetic layers 10a to 10p. The thicknesses of the oxide films are, for example, 5 nm or more 60 nm or less. The oxide film may include one or more layers.

The element body 2 contains resins. The resins are present between the plurality of soft magnetic metal particles M. The resin is an insulating resin having electrical insulating properties. The insulating resin includes, for example, silicone resin, phenol resin, acrylic resin, or epoxy resin.

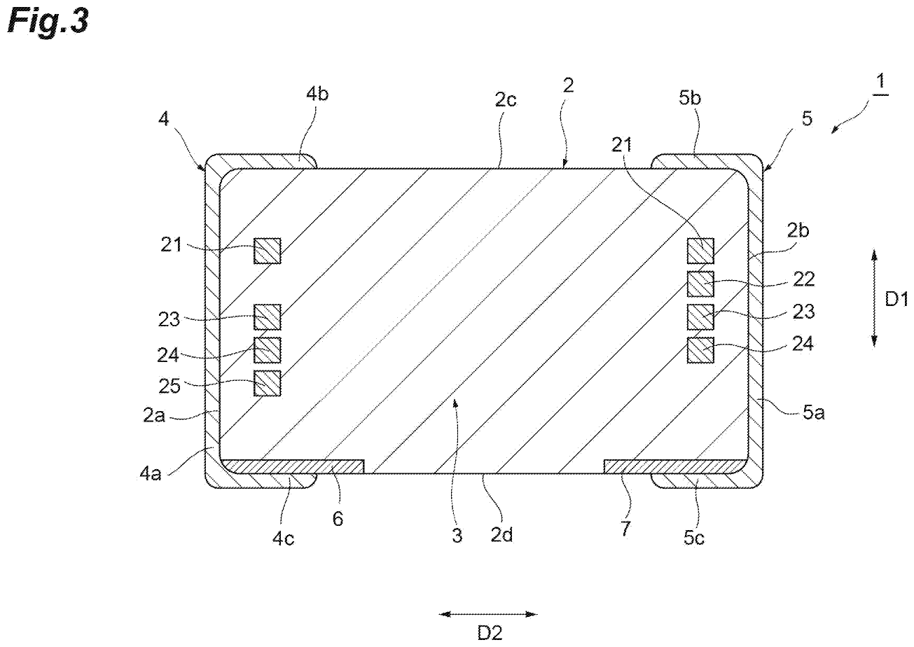

As shown in FIG. 3, in the element body 2, a part of the main surface 2d forms steps. To be specific, a portion close to each of the end surfaces 2a and the end surface 2b is recessed toward the main surface 2c from the central portion in the main surface 2d.

As shown in FIGS. 1 and 3, the first external electrode 4 and the second external electrode 5 are disposed on the element body 2. The first external electrode 4 and the second external electrode 5 are disposed on an outer surface of the element body 2. The first external electrode 4 is located at one end portion of the second direction D2 of the element body 2. The second external electrode 5 is located at the other end portion of the second direction D2 of the element body 2. The first external electrode 4 and the second external electrode 5 are spaced apart from each other in the second direction D2.

The first external electrode 4 includes a first electrode portion 4a located on the end surface 2a, a second electrode portion 4b located on the main surface 2c, a third electrode portion 4c located on the main surface 2d, a fourth electrode portion 4d located on the side surface 2e, and a fifth electrode portion 4e located on a side surface 2f. The first electrode portion 4a extends along the first direction D1 and the third direction D3 and has a rectangular shape when viewed from the second direction D2. The second electrode portion 4b extends along the second direction D2 and the third direction D3 and has a rectangular shape when viewed from the first direction D1. The third electrode portion 4c extends along the second direction D2 and the third direction D3 and has a rectangular shape when viewed from the first direction D1. The fourth electrode portion 4d extends along the first direction D1 and the second direction D2 and has a rectangular shape when viewed from the third direction D3. The fifth electrode portion 4e extends along the first direction D1 and the second direction D2 and has a rectangular shape when viewed from the third direction D3.

The first electrode portion 4a, the second electrode portion 4b, the third electrode portion 4c, the fourth electrode portion 4d, and the fifth electrode portion 4e are connected at the ridges of the element body 2, and are electrically connected to each other. The first external electrode 4 is formed on five surfaces that include the end surface 2a, the pair of main surfaces 2c and 2d, and the pair of side surfaces 2e and 2f. The first electrode portion 4a, the second electrode portion 4b, the third electrode portion 4c, the fourth electrode portion 4d, and the fifth electrode portion 4e are integrally formed.

The second external electrode 5 includes a first electrode portion 5a located on the end surface 2b, a second electrode portion 5b located on the main surface 2c, a third electrode portion 5c located on the main surface 2d, a fourth electrode portion 5d located on the side surface 2e, and a fifth electrode portion 5e located on the side surface 2f. The first electrode portion 5a extends along the first direction D1 and the third direction D3 and has a rectangular shape when viewed from the second direction D2. The second electrode portion 5b extends along the second direction D2 and the third direction D3 and has a rectangular shape when viewed from the first direction D1. The third electrode portion 5c extends along the second direction D2 and the third direction D3 and has a rectangular shape when viewed from the first direction D1. The fourth electrode portion 5d extends along the first direction D1 and the second direction D2 and has a rectangular shape when viewed from the third direction D3. The fifth electrode portion 5e extends along the first direction D1 and the second direction D2 and has a rectangular shape when viewed from the third direction D3.

The first electrode portion 5a, the second electrode portion 5b, the third electrode portion 5c, the fourth electrode portion 5d, and the fifth electrode portion 5e are connected at the ridges of the element body 2, and are electrically connected to each other. The second external electrode 5 are formed on five surfaces that include the end surface 2b, the pair of main surfaces 2c and 2d, and the pair of side surfaces 2e and 2f. The first electrode portion 5a, the second electrode portion 5b, the third electrode portion 5c, the fourth electrode portion 5d, and the fifth electrode portion 5e are integrally formed.

The first external electrode 4 and the second external electrode 5 are conductive resin layers. As the conductive resin, a thermosetting resin mixed with a conductive material, an organic solvent and the like is used. As the conductive material, for example, a conductive filler is used. The conductive filler is a metal powder. As the metal powder, for example, Ag powder is used. As the thermosetting resin, for example, a phenol resin, an acrylic resin, a silicone resin, an epoxy resin, or a polyimide resin is used.

The first electrode part 6 and the second electrode part 7 are located in the main surface 2d so as to be spaced apart from each other in the second direction D2. The first electrode part 6 and the second electrode part 7 have rectangular shapes when viewed from the first direction D1 and extend along the second direction D2 and the third direction D3. The first electrode part 6 and the second electrode part 7 are provided on the entire main surface 2d of the third direction D3. The first electrode part 6 is covered with the third electrode portion 4c and is electrically connected to the first external electrode 4. A portion of the first electrode part 6 close to the second electrode part 7 is exposed from the third electrode portion 4c. The second electrode part 7 is covered with the third electrode portion 5c and is electrically connected to the second external electrode 5. A portion of the second electrode part 7 close to the first electrode part 6 is exposed from the third electrode portion 5c.

The first electrode part 6 is provided so as to fill the step provided on the end surface 2a side of the main surface 2d. The first electrode part 6 is flush with the main surface 2d, the end surface 2a, the side surface 2e, and the side surface 2f. It can be said that the first electrode part 6 is buried in the element body 2 so as to be exposed from the main surface 2d, the end surface 2a, the side surface 2e and the side surface 2f. The second electrode part 7 is provided so as to fill the step provided on the end surface 2b side of the main surface 2d. The second electrode part 7 is flush with the main surface 2d, the end surface 2b, the side surface 2e, and the side surface 2f. It can be said that the second electrode part 7 is buried in the element body 2 so as to be exposed from the main surface 2d, the end surface 2b, the side surface 2e and the side surface 2f.

As shown in FIG. 2, the first electrode part 6 and the second electrode part 7 are provided so as to sandwich the magnetic layer 10p in the second direction D2. The first electrode part 6, the second electrode part 7, and the magnetic layer 10p have the same thicknesses, that is, the same lengths in the first direction D1. The first electrode part 6 and the second electrode part 7 are, for example, printing pastes or plated conductors. The first electrode part 6 and the second electrode part 7 contain electrically conductive material. The conductive material is, for example, Ag, Pd, Cu, Al, or Ni.

As shown in FIGS. 2 and 3, the multilayer coil component 1 further includes a coil 3, the first connection conductor 8 and the second connection conductor 9.

The coil 3 is disposed in the element body 2. In the present embodiment, the coil 3 is disposed at the center of the element body 2 in the second direction D2 and the third direction D3. In other words, a separation distance between the coil 3 and the end surface 2a is equal to a separation distance between the coil 3 and the end surface 2b. A separation distance between the coil 3 and the side surface 2e is equal to a separation distance between the coil 3 and the side surface 2f. In the present specification, the separation distance means the shortest separation distance.

The coil 3 includes coil conductors 21 to 25 and through-hole conductors 31 to 36 which are electrically connected to each other. The coil conductors 21 to 25 and the through-hole conductors 31 to 36 are inner conductors disposed inside the coil 3 together with the first connection conductor 8 and the second connection conductor 9. The internal conductor is, for example, a printed paste or a plated conductor. The inner conductor includes an electrically conductive material. The conductive material is, for example, Ag, Pd, Cu, Al, or Ni. The inner conductors are made of the same material, for example. The inner conductor is made of, for example, the same material as the first electrode part 6 and the second electrode part 7.

The coil axes of the coils 3 are provided along the first direction D1. The coil conductors 21 to 25 are arranged so as to at least partially overlap each other when viewed from the first direction D1. One end portion 21a of a coil conductor 21 constitutes one end portion 3a of the coil 3. The other end portion 21b of the coil conductor 21 is connected by a through-hole conductor 32 to one end portion 22a of a coil conductor 22. The other end portion 22b of the coil conductor 22 is connected by a through-hole conductor 33 to one end portion 23a of a coil conductor 23. The other end portion 23b of the coil conductor 23 is connected by a through-hole conductor 34 to one end portion 24a of a coil conductor 24. The other end portion 24b of the coil conductor 24 is connected by a through-hole conductor 35 to one end portion 25a of a coil conductor 25. The other end portion 25b of the coil conductor 25 constitutes the other end portion 3b of the coil 3.

Each of the end portions 21a to 25a and 21b to 25b of the coil conductors 21 to 25 is formed in a circular shape when viewed from the first direction D1. When viewed from the first direction D1, the diameter of each end portion 21a to 25a and 21b to 25b is greater than a line width of each coil conductor 21 to 25. The line width is line widths of the portions other than the end portions 21a to 25a and 21b to 25b of the coil conductors 21 to 25. Since each end portion 21a to 25a and 21b to 25b is enlarged, the end portions 21a to 25a and 21b to 25b can be easily connected to the through-hole conductors 31 to 36. The diameter of each end portion 21a to 25a and 21b to 25b is equivalent to the diameters of each through-hole conductor 31 to 36.

The coil conductor 21 is provided on the magnetic layer 10d. The coil conductor 22 is provided on the magnetic layer 10f. The coil conductor 23 is provided on the magnetic layer 10h. The coil conductor 24 is provided on the magnetic layer 10j. The coil conductor 25 is provided on the magnetic layer 10l.

The lengths of the coil conductors 21 to 25 in the first direction D1 are equal to each other in present embodiment. The lengths of the coil conductors 21 to 25 in the first direction D1 are equivalent to the thicknesses of the corresponding magnetic layer 10d, 10f, 10h, 10j and 10l.

The through-hole conductor 31 is provided on the magnetic layer 10c. The through-hole conductor 32 is provided on the magnetic layer 10e. The through-hole conductor 33 is provided on the magnetic layer 10g. The through-hole conductor 34 is provided on the magnetic layer 10i. The through-hole conductor 35 is provided on the magnetic layer 10k. The through-hole conductor 36 is provided on the magnetic layer 10m. Each of the through-hole conductors 31 to 36 is provided so as to pass through the corresponding magnetic layer 10c, 10e, 10g, 10i, 10k, and 10m in the thickness direction (that is, the first direction D1) thereof.

The lengths of the through-hole conductors 31 to 36 in the first direction D1 are equal to each other in present embodiment. The lengths of the through-hole conductors 31 to 36 in the first direction D1 are equal to the thicknesses of the corresponding magnetic layers 10c, 10e, 10g, 10i, 10k, and 10m.

The first connection conductor 8 connects one end portion 3a of the coil 3 to the first electrode portion 4a of the first external electrode 4. The first connection conductor 8 extends in the second direction D2. The first connection conductor 8 has a first end portion 8a and a second end portion 8b. The first end portion 8a is exposed from the end surface 2a and connected to the first electrode portion 4a. The first end portion 8a includes a connection surface 8c in contact with the first electrode portion 4a.

The second end portion 8b is connected to one end portion 3a of the coil 3 by the through-hole conductor 31. The second end portion 8b is formed in a circular shape when viewed from the first direction D1. As viewed from the first direction D1, the diameter of the second end portion 8b is greater than the line widths of portions other than both end portions 8a and 8b of the first connection conductor 8. Since the second end portion 8b is enlarged in this manner, the second end portion 8b and the through-hole conductor 31 are easily connected.

The second connection conductor 9 connects the other end portion 3b of the coil 3 and the first electrode portion 5a of the second external electrode 5. The second connection conductor 9 extends in the second direction D2. The second connection conductor 9 has a first end portion 9a and a second end portion 9b. The first end portion 9a is exposed from the end surface 2b and connected to the first electrode portion 5a. The first end portion 9a includes a connection surface 9c in contact with the first electrode portion 5a.

The second end portion 9b is connected to the other end portion 3b of the coil 3 by the through-hole conductor 36. The second end portion 9b is formed in a circular shape when viewed from the first direction D1. As viewed from the first direction D1, the diameter of the second end portion 9b is greater than the line widths of portions other than both end portions 9a and 9b of the second connection conductor 9. Since the second end portion 9b is enlarged in this manner, the second end portion 9b and the through-hole conductor 36 are easily connected.

As shown in FIG. 2, the magnetic layer 10e is disposed between the coil conductor 21 and the coil conductor 22 that are adjacent in the first direction D1. The magnetic layer 10g is disposed between the coil conductor 22 and the coil conductor 23 that are adjacent in the first direction D1. The magnetic layer 10i is disposed between the coil conductor 23 and the coil conductor 24 that are adjacent in the first direction D1. The magnetic layer 10k is disposed between the coil conductor 24 and the coil conductor 25 that are adjacent in the first direction D1. Each magnetic layer 10e, 10g, 10i, and 10k has a multilayer structure.

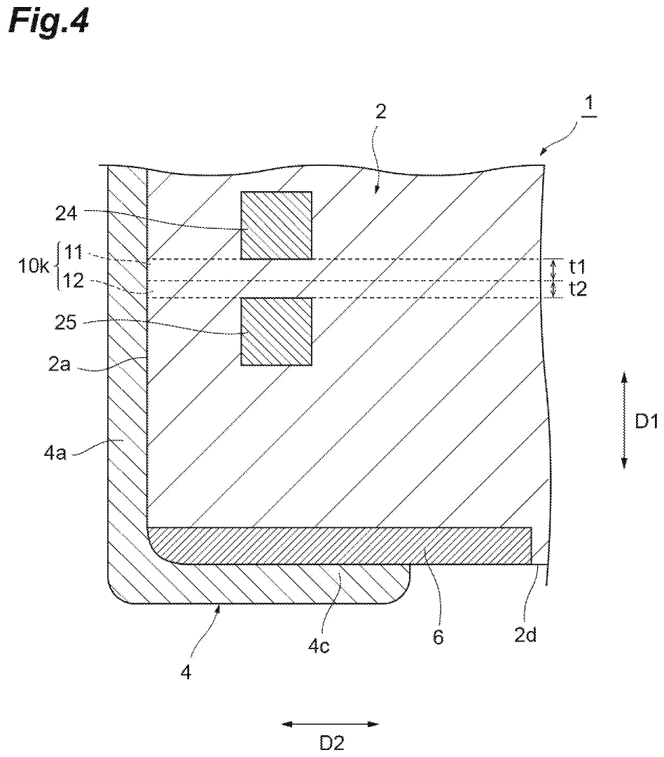

As shown in FIG. 4, the magnetic layer 10k includes a first magnetic layer 11 and a second magnetic layer 12 laminated in the first direction D1. Although not shown, each of the magnetic layers 10e, 10g, and 10i has the same configuration as the magnetic layer 10k, and includes the first magnetic layer 11 and the second magnetic layer 12. Each of the magnetic layers 10e, 10g, 10i, and 10k has a double layer structure in which the first magnetic layer 11 and the second magnetic layer 12 are laminated. In the present embodiment, in any of the magnetic layers 10e, 10g, 10i, and 10k, the second magnetic layer 12 is disposed closer to the main surface 2d than the first magnetic layer 11, but the first magnetic layer 11 may be disposed closer to the main surface 2d than the second magnetic layer 12. Which of the first magnetic layer 11 and the second magnetic layer 12 is disposed closer to the main surface 2d may be different for each of the magnetic layers 10e, 10g, 10i, and 10k.

The first magnetic layer 11 and the second magnetic layer 12 are provided in the same size as the element body 2 when viewed from the first direction D1. The thickness (length in the first direction D1) t1 of the first magnetic layer 11 is, for example, not less than 1 μm and not more than 20 μm. The thickness (length in the first direction D1) t2 of the second magnetic layer 12 is, for example, not less than 1 μm and not more than 20 μm. In the present embodiment, the first magnetic layer 11 is thinner than the second magnetic layer 12.

As shown in FIG. 5, the soft magnetic metal particle M included in the first magnetic layer 11 is soft magnetic metal particle M1. The soft magnetic metal particle M included in the second magnetic layer 12 is soft magnetic metal particle M2. Two or more soft magnetic metal particles M including one soft magnetic metal particle M1 and one soft magnetic metal particle M2 are disposed along the first direction D1 between the coil conductor 24 and the coil conductor 25 that are adjacent to each other in the first direction D1. In FIG. 5, illustration of resins present between the plurality of the soft magnetic metal particles M is omitted.

The average particle diameter of the soft magnetic metal particles M2 is larger than the average particle diameter of the soft magnetic metal particles M1. The average particle diameter of the soft magnetic metal particles M1 is, for example, 0.5 μm or more and 5 μm or less. The average particle diameter of the soft magnetic metal particles M2 is, for example, 1 μm or more and 10 μm or less. The average particle diameter of the soft magnetic metal particles M2 is, for example, 1.1 times or more and 20 times or less the average particle diameter of the soft magnetic metal particles M1.

The average particle diameter of the soft magnetic metal particles M1 and the average particle diameter of the soft magnetic metal particles M2 are obtained, for example, as follows. Cross-sectional photograph of the multilayer coil component 1 is obtained, the cross-sectional photograph including the element body 2, the first external electrode 4, and the second external electrode 5. The cross-sectional photograph is obtained, for example, by photographing a cross-section obtained by cutting the multilayer coil component 1 in a plane parallel to the side surfaces 2e and 2f and separated from the side surfaces 2e and 2f by predetermined distances. In this case, the plane may be located equidistant from the pair of side surfaces 2e and 2f. The obtained cross-sectional photograph is subjected to image processing by software. The boundary between the soft magnetic metal particles M1 and M2 is determined by image processing, and the area of each of the soft magnetic metal particles M1 and M2 is obtained. Based on the areas of the obtained soft magnetic metal particles M1 and M2, particle diameters converted into equivalent circle diameters are obtained. Here, for each of the soft magnetic metal particles M1 and the soft magnetic metal particles M2, 100 or more particle diameters are calculated to obtain a particle size distribution. A particle diameter (d50) at an integrated value of 50% in the obtained particle size distribution is defined as an “average particle diameter”. The shapes of the soft magnetic metal particles M1 and M2 are not particularly limited.

Between the first magnetic layer 11 and the second magnetic layer 12, there is a mixed region R in which the soft magnetic metal particles M having a small particle diameter (that is, the soft magnetic metal particles M1) and the soft magnetic metal particles M having a large particle diameter (that is, the soft magnetic metal particles M2) are mixed. The first magnetic layer 11 and the second magnetic layer 12 are disposed so as to sandwich the mixed region R in the first direction D1. The thicknesses t1 and t2 described above do not include thickness of the mixed region R.

When viewed from the first direction D1, the magnetic layers 10d, 10f, 10h, 10j, and 10l are provided around the corresponding coil conductors 21 to 25, and constitute the same layer as the corresponding coil conductors 21 to 25. In the magnetic layers 10d, 10f, 10h, 10j, and 10l, the corresponding coil conductors 21 to 25 are provided so as to penetrate through the magnetic layers 10d, 10f, 10h, 10j, and 10l in the thickness direction thereof (the first direction D1). The soft magnetic metal particle M included in the magnetic layers 10d, 10f, 10h, 10j, and 10l is a soft magnetic metal particle M3. The average particle diameter of the soft magnetic metal particles M3 is greater than the average particle diameter of the soft magnetic metal particles M1 and greater than the average particle diameter of the soft magnetic metal particles M2. The average particle diameter of the soft magnetic metal particles M3 is, for example, 5 μm or more and 50 μm or less. The average particle diameter of the soft magnetic metal particles M3 is obtained in the same way as the average particle diameters of the soft magnetic metal particles M1 and M2, for example. The particle shape of the soft magnetic metal particle M3 is not particularly limited.

In the present embodiment, each magnetic layer 10d, 10f, 10h, 10j, and 10l has a single layer structure, but may have a multilayer structure including a plurality of magnetic layers laminated in the first direction D1. Even in the case of the multilayer structure, all of the soft magnetic metal particles M included in each of the magnetic layers 10d, 10f, 10h, 10j, and 10l are the soft magnetic metal particles M3.

The magnetic layers 10a, 10b, 10c, 10m, 10n, 10o, and 10p are disposed outside the coil 3 in the first direction D1. The magnetic layers 10a, 10b, and 10c are provided on one side (the main surface 2c side) of the coil 3 in the first direction D1. The magnetic layers 10m, 10n, 10o, and 10p are provided on the other side (the main surface 2d side) of the coil 3 in the first direction D1. The magnetic layers 10a, 10b, and 10c and the magnetic layers 10m, 10n, 10o, and 10p are disposed so as to sandwich the coil 3 in the first direction D1. All of the soft magnetic metal particles M included in each magnetic layer 10a, 10b, 10c, 10m, 10n, 10o, and 10p are the soft magnetic metal particles M3.

Next, a method of manufacturing the multilayer coil component 1 will be described.

A first slurry containing the soft magnetic metal particles M1, a second slurry containing the soft magnetic metal particles M2, and a third slurry containing the soft magnetic metal particles M3 are prepared. Each slurry is obtained by mixing soft magnetic metal particles M1, M2, and M3 with insulating resins, solvents, and the like.

The third slurry is provided on a base (e.g., a polyethylene terephthalate film) by, for example, a screen printing method or a doctor-blade method to form a green sheet serving as the magnetic layers 10a on the substrate. Similarly, a green sheet serving as the magnetic layers 10o are formed on a base.

A conductor pattern to be the first connection conductor 8 is formed on a base by a screen printing method or a plating method. Subsequently, the third slurry is applied onto the base by, for example, a screen printing method so as to fill around the conductor pattern. Thus, a green sheet serving as the magnetic layers 10b is formed on the base. Green sheets corresponding to the plurality of magnetic layers 10c, 10d, 10f, 10h, 10j, 10l, 10m, and 10n are also formed by forming corresponding conductive patterns on bases and then applying the third slurry to fill the peripheries thereof.

A conductor pattern to be the through-hole conductor 32 is formed on a base by a screen printing method or a plating method. Subsequently, the second slurry and the first slurry are applied in this order on the base by, for example, a screen printing method so as to fill around the conductive pattern. Thus, a green sheet serving as the plurality of the magnetic layers 10e is formed on the base. Green sheets to be the plurality of magnetic layers 10g, 10i, and 10k are also formed by forming corresponding conductor patterns on bases and then applying the second slurry and the first slurry in this order so as to fill the periphery thereof.

Next, the green sheets to be the plurality of magnetic layers 10a to 10p are transferred and laminated together with the conductor patterns in this order. The green sheets are pressed in the laminating direction to form a laminate. Subsequently, the laminate of the green sheets is fired to form a laminate substrate. Subsequently, the laminate substrate is cut into chips having a predetermined size by a cutting machine including a rotary blade to form individualized laminates.

Subsequently, the laminate is immersed in a resin solution to impregnate the laminate with the resin. Thus, the element body 2 is formed. Resin electrode layers serving as the first external electrode 4 and the second external electrode 5 are formed on both ends of the element body 2 by, for example, a dipping method. As described above, the multilayer coil component 1 is formed.

As described above, in the multilayer coil component 1 according to the present embodiment, the first magnetic layer 11 and the second magnetic layer 12 are disposed between adjacent coil conductors among the coil conductors 21 to 25, that is, between the coil conductor 21 and the coil conductor 22, between the coil conductor 22 and the coil conductor 23, between the coil conductor 23 and the coil conductor 24, and between the coil conductor 24 and the coil conductor 25. The average particle diameter of the soft magnetic metal particles M1 included in the first magnetic layer 11 is different from the average particle diameter of the soft magnetic metal particles M2 included in the second magnetic layer 12. Therefore, two or more soft magnetic metal particles M including at least one soft magnetic metal particle M1 and one soft magnetic metal particle M2 are likely to be disposed along the first direction D1 between the adjacent coil conductors among the coil conductors 21 to 25. Accordingly, it is possible to secure the withstand voltage between the adjacent coil conductors compared to a case in which a magnetic layer is disposed as a single layer. In addition, compared with the case where the first magnetic layer 11 having the small average particle diameter is disposed as a single layer, the permeability is improved. As a result, the L value of the coil 3 can be increased.

The thickness t1 of the first magnetic layer 11 is thicker than the thickness t2 of the second magnetic layer 12. As a result, the withstand voltage between the adjacent coil conductors can be reliably ensured.

Each of the magnetic layers 10d, 10f, 10h, 10j, and 10l is provided around the corresponding coil conductor among the coil conductors 21 to 25 when viewed from the first direction D1, and constitutes the same layer as the corresponding coil conductor. The average particle diameter of the soft magnetic metal particles M3 included in each of the magnetic layers 10d, 10f, 10h, 10j, and 10l is larger than the average particle diameter of the soft magnetic metal particles M1. Therefore, the L value of the coil 3 can be further increased compared to the case where the average particle diameter of the soft magnetic metal particles M3 is smaller than the average particle diameter of the soft magnetic metal particles M1. The average particle diameter of the soft magnetic metal particles M3 is greater than the average particle diameter of the soft magnetic metal particles M2. Therefore, the L value of the coil 3 can be further increased compared to the case where the average particle diameter of the soft magnetic metal particles M3 is smaller than the average particle diameter of the soft magnetic metal particles M2.

Between the first magnetic layer 11 and the second magnetic layer 12, there is the mixed region R in which the soft magnetic metal particles M1 having small particle diameters and the soft magnetic metal particles M2 having large particle diameters are mixed. Since there are three layers of the first magnetic layer 11, the second magnetic layer 12, and the mixed region R between the adjacent coil conductors, the withstand voltage between the adjacent coil conductors can be more reliably ensured.

### Second Embodiment

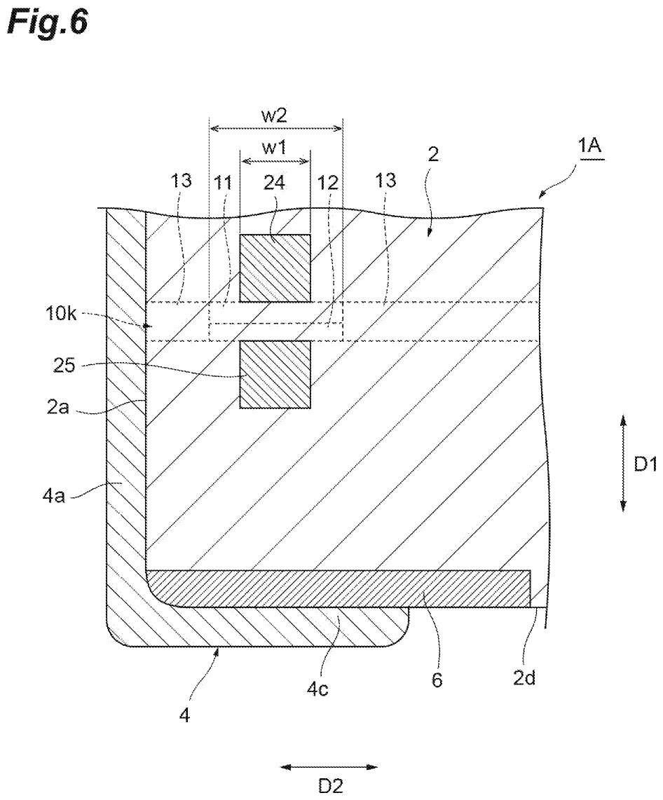

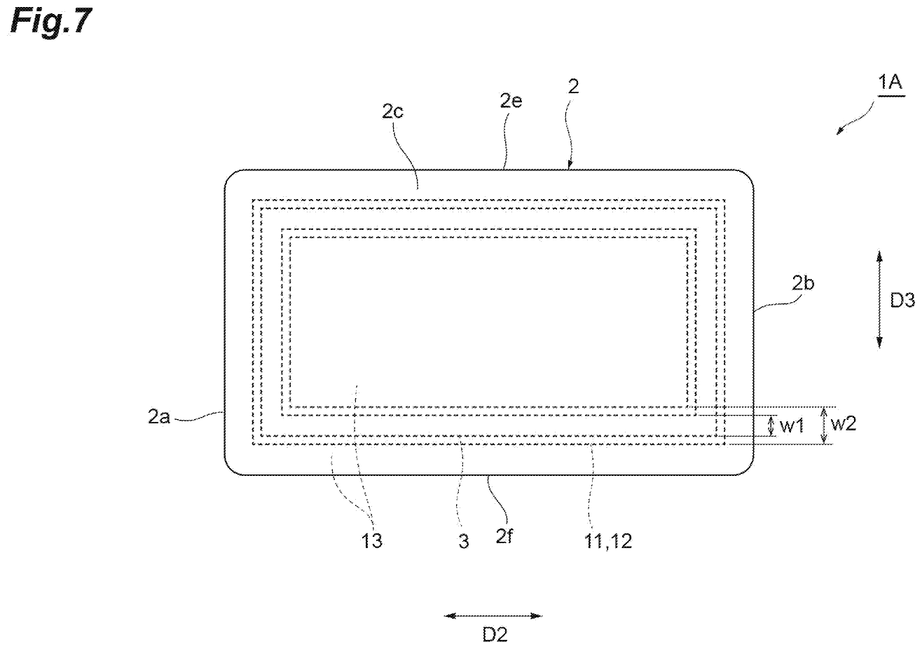

A multilayer coil component 1A according to the second embodiment will be described with reference to FIGS. 6 and 7. In FIG. 7, illustration of the first external electrode 4 and the second external electrode 5 is omitted. As shown in FIGS. 6 and 7, in the multilayer coil component 1A, each of the first magnetic layer 11 and the second magnetic layer 12 overlaps the coil 3 (i.e., the coil conductors 21 to 25) and has the line width w2 wider than the line width w1 of the coil 3 (i.e., the coil conductors 21 to 25) when viewed from the first direction D1. Here, when viewed from the first direction D1, the line width w1 is a line width of a portion of the coil conductors 21 to 25 other than the end portions 21a to 25a and the end portions 21b to 25b.

Each of the first magnetic layer 11 and the second magnetic layer 12 has a rectangular frame shape with the line width w2 when viewed from the first direction D1. The first magnetic layer 11 and the second magnetic layer 12 have the same shape as viewed from the first direction D1. The first magnetic layer 11 and the second magnetic layer 12 are spaced apart from the end surfaces 2a and 2b and the side surfaces 2e and 2f.

When viewed from the first direction D1, the magnetic layer 10k also includes a third magnetic layer 13 that is disposed around the first magnetic layer 11 and the second magnetic layer 12 and constitutes the same layer as the first magnetic layer 11 and the second magnetic layer 12. The third magnetic layer 13 is provided both outside and inside the first magnetic layer 11 and the second magnetic layer 12 as viewed from the first direction D1. The soft magnetic metal particle M included in the third magnetic layer 13 is the soft magnetic metal particle M3. The average particle diameter of the soft magnetic metal particles M3 is greater than the average particle diameter of the soft magnetic metal particles M1. Therefore, in the multilayer coil component 1A, the L value of the coil 3 can be further increased compared to a configuration in which the soft magnetic metal particle M included in the third magnetic layer 13 is the soft magnetic metal particle M1.

The average particle diameter of the soft magnetic metal particles M3 is greater than the average particle diameter of the soft magnetic metal particles M2. Therefore, in the multilayer coil component 1A, the L value of the coil 3 can be further increased compared to the multilayer coil component 1 in which the first magnetic layer 11 and the second magnetic layer 12 are provided on the entire surface.

In the multilayer coil component 1A, each of the first magnetic layer 11 and the second magnetic layer 12 has the rectangular frame shape with the line width w2 when viewed from the first direction D1, but the shapes of the first magnetic layer 11 and the second magnetic layer 12 are not limited. The first magnetic layer 11 and the second magnetic layer 12 may be provided with the line width w2, for example, in a region overlap both the adjacent coil conductors when viewed from the first direction D1. In this case, the shapes of the first magnetic layer 11 and the second magnetic layer 12 are different depending on the magnetic layers 10e, 10g, 10i, and 10k. Compared to the case where the first magnetic layer 11 and the second magnetic layer 12 are provided in a rectangular frame shape, the region where the soft magnetic metal particles M3 is provided increases, and thus the L value of the coil 3 can be further increased.

### Third Embodiment

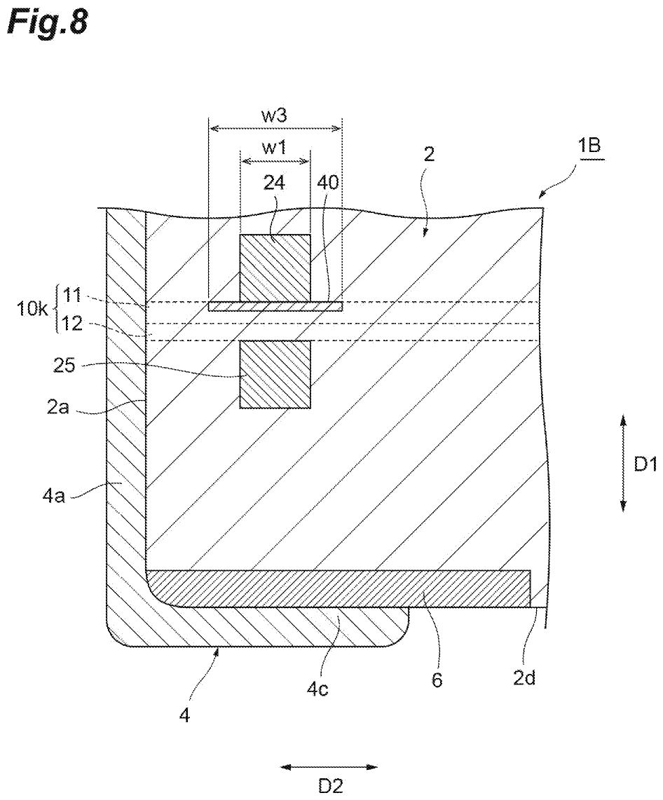

A multilayer coil component 1B according to the third embodiment will be described with reference to FIG. 8. As shown in FIG. 8, the multilayer coil component 1B further includes a high resistance portion 40 having an electrical resistivity higher than that of each of the first magnetic layer 11 and the second magnetic layer 12. The high resistance portion 40 is disposed between the adjacent coil conductors together with the first magnetic layer 11 and the second magnetic layer 12. The high resistance portion 40 is provided so as to be in contact with one of two adjacent coil conductors. In the magnetic layer 10k, the high resistance portion 40 is provided in contact with, for example, the coil conductor 24, but may be provided in contact with the coil conductor 25.

Although illustration of a plan view is omitted, the high resistance portion 40 overlaps with the coil 3 (that is, the coil conductors 21 to 25) when viewed from the first direction D1, and is provided with a line width w3 wider than the line width w1 of the coil 3 (that is, the coil conductors 21 to 25). The high resistance portion 40 has a rectangular frame shape with the line width w3 when viewed from the first direction D1. The high resistance portion 40 is spaced apart from the end surfaces 2a and 2b and the side surfaces 2e and 2f. The thickness of the high resistance portion 40 is thinner than, for example, the thickness t1 of the first magnetic layer 11 and the thickness t2 of the second magnetic layer 12. The thickness (length in the first direction D1) of the high resistance portion 40 is, for example, 0.1 μm or more and 5 μm or less.

The high resistance portion 40 is formed, for example, of ZrO₂. The high resistance portion 40 may be a void. In the case where the high resistance portion 40 is the void, a laminate of green sheets is formed by arranging resin which disappears at the time of firing at a position where the high resistance portion 40 are to be formed. By firing the laminate of the green sheet, the resin disappears and void is formed.

Since the multilayer coil component 1B includes the high resistance portion 40, it is possible to reliably secure the withstand voltage between the coil conductors. In the multilayer coil component 1B, the high resistance portion 40 has the rectangular frame shape with the line width w3 when viewed from the first direction D1, but the shape of the high resistance portion 40 is not limited. For example, the high resistance portion 40 may be provided with the line width w3 in a region overlapping both of the adjacent conductors when viewed from the first direction D1. In this case, the shape of the high resistance portion 40 varies depending on the magnetic layers 10e, 10g, 10i, and 10k. Compared to the case where the high resistance portion 40 is provided with a rectangular frame shape, the region where the soft magnetic metal particles M is provided is increased, and thus the L value of the coil 3 can be further increased.

### Fourth Embodiment

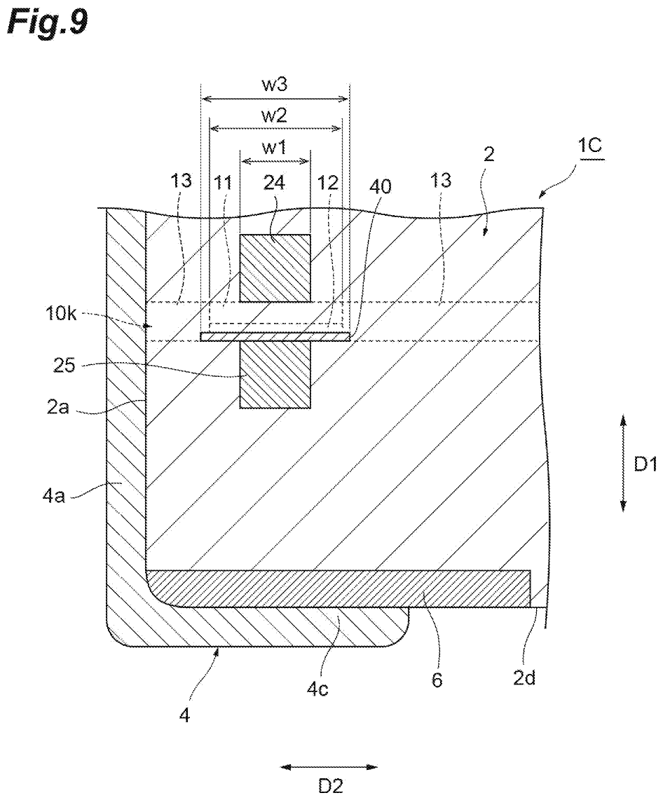

A multilayer coil component 1C according to the fourth embodiment will be described with reference to FIG. 9. As illustrated in FIG. 9, in the multilayer coil component 1C according to the fourth embodiment, similarly to the multilayer coil component 1A, each of the first magnetic layer 11 and the second magnetic layer 12 overlaps the coil 3 and is provided with the line width w2 wider than the line width w1 of the coil 3 when viewed from the first direction D1. In addition, the multilayer coil component 1C further includes the high resistance portion 40 having an electrical resistivity higher than the respective electrical resistivities of the first magnetic layer 11 and the second magnetic layer 12, similar to the multilayer coil component 1B. The high resistance portion 40 overlaps with the coil 3 and is provided with the line width w3 wider than the line width w1 in the coil 3 when viewed from the first direction D1.

In the present embodiment, the line width w3 is wider than the line width w2, but the line width w3 may be equivalent to the line width w2 or narrower than the line width w2. In the magnetic layer 10k, the high resistance portion 40 is provided in contact with, for example, the coil conductor 25, but may be provided in contact with the coil conductor 24. Each of the first magnetic layer 11, the second magnetic layer 12, and the high resistance portion 40 has, for example, a rectangular frame shape when viewed from the first direction D1. Since the multilayer coil component 1C includes the high resistance portion 40, it is possible to reliably secure the withstand voltage between the coil conductors.

When viewed from the first direction D1, the third magnetic layer 13 is provided around the first magnetic layer 11, the second magnetic layer 12, and the high resistance portion 40. The third magnetic layer 13 constitutes the same layer as the first magnetic layer 11, the second magnetic layer 12, and the high resistance portion 40. Since the average particle diameter of the soft magnetic metal particles M3 included in the third magnetic layer 13 is larger than the average particle diameter of the soft magnetic metal particles M1 and the average particle diameter of the soft magnetic metal particles M2, the L value of the coil 3 can be further increased in the multilayer coil component 1C.

Although the embodiments of the present invention have been described above, the present invention is not necessarily limited to the above-described embodiments, and various modifications can be made without departing from the scope of the present invention.

The second end portion 8b of the first connection conductor 8, the second end portion 9b of the second connection conductor 9, and the end portions 21a to 25a and the end portions 21b to 25b of coil conductors 21 to 25 are enlarged when viewed from the first direction D1, but may not be enlarged.

While the first connection conductor 8 is exposed to the end surface 2a and the second connection conductor 9 is exposed to the end surface 2b, the first connection conductor 8 and the second connection conductor 9 may be exposed to the main surface 2d. In this case, the first external electrode 4 and the second external electrode 5 may be bottom electrodes provided on the main surface 2d. Also, the laminating direction of the magnetic layers may be the second direction D2 or the third direction D3.

The above-described embodiments and modifications may be appropriately combined.

1. A multilayer coil component comprising:
an element body including a plurality of magnetic layers that includes soft magnetic metal particles and is laminated in a first direction; and
a coil disposed in the element body,
wherein the coil includes a plurality of coil conductors electrically connected to each other,
the plurality of magnetic layers includes a first magnetic layer and a second magnetic layer laminated between two coil conductors adjacent to each other in the first direction, and
an average particle diameter of soft magnetic metal particles included in the second magnetic layer is larger than an average particle diameter of soft magnetic metal particles included in the first magnetic layer.

2. The multilayer coil component according to claim 1, wherein the first magnetic layer is thinner than the second magnetic layer.

3. The multilayer coil component according to claim 1, wherein the first magnetic layer is thicker than the second magnetic layer.

4. The multilayer coil component according to claim 1, wherein the plurality of magnetic layers further includes a plurality of third magnetic layers that is disposed around a corresponding coil conductor when viewed from the first direction and constitutes the same layer as the corresponding coil conductor, and
an average particle diameter of soft magnetic metal particles included in the plurality of third magnetic layers is larger than the average particle diameter of soft magnetic metal particles included in the first magnetic layer.

5. The multilayer coil component according to claim 1, wherein each of the first magnetic layer and the second magnetic layer overlaps with the plurality of coil conductors when viewed from the first direction and has a line width wider than a line width of the plurality of coil conductors, and
the plurality of magnetic layers further includes a third magnetic layer that is disposed around the first magnetic layer and the second magnetic layer when viewed from the first direction and constitutes the same layer as the first magnetic layer and the second magnetic layer, and
an average particle diameter of soft magnetic metal particles included in the third magnetic layer is larger than the average particle diameter of soft magnetic metal particles included in the first magnetic layer.

6. The multilayer coil component according to claim 4, wherein the average particle diameter of soft magnetic metal particles included in the third magnetic layer is larger than the average particle diameter of soft magnetic metal particles included in the second magnetic layer.

7. The multilayer coil component according to claim 5, wherein the average particle diameter of soft magnetic metal particles included in the third magnetic layer is larger than the average particle diameter of soft magnetic metal particles included in the second magnetic layer.

8. The multilayer coil component according to claim 1, further comprising a high resistance portion disposed between the two coil conductors and having an electrical resistivity higher than an electrical resistivity of each of the first magnetic layer and the second magnetic layer,
wherein the high resistance portion overlaps the plurality of coil conductors when viewed from the first direction and has a line width wider than a line width of the plurality of coil conductors.

9. The multilayer coil component according to claim 8, wherein the high resistance portion is disposed so as to be in contact with one of the two coil conductors.

10. The multilayer coil component according to claim 1, wherein a mixed region in which soft magnetic metal particles having small particle diameters and soft magnetic metal particles having large particle diameters are mixed is present between the first magnetic layer and the second magnetic layer.
